(19) United States
(12) Patent Application Publication
(10) Pub. No.: US 2007/0133208 A1
(43) Pub. Date: Jun. 14, 2007

(54) Dynamic aperture for display systems

(75) Inventors: Steven Edward Smith, Coppell, TX (US); Stephen Wesley Marshall, Richardson, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/298,257

(22) Filed: Dec. 9, 2005

(51) Int. Cl. B60Q 1/14

(52) U.S. Cl. 362/284

(57) ABSTRACT

System and apparatus for improving the display quality of display systems. A preferred embodiment comprises a planar object configured to variably pass light produced by a light source located on a first side of the planar object to a second side of the planar object, and a motor coupled to the planar object, the motor to rotate the planar object and change the amount of light passed by the planar object. The planar object includes a semi-circular beveled portion formed on a first side of the planar object. A slot with monotonically increasing width is cut along a spine of the semi-circular beveled portion and through the planar object and depending upon a width of the slot that is in front of the light source, the planar object passes a different amount of light. The motor is a DC brushless motor or a limited angular torque motor.

### TECHNICAL FIELD

The present invention relates generally to a system and an apparatus for displaying images, and more particularly to a system and an apparatus for improving the display quality of display systems.

### BACKGROUND

Display systems for use in displaying still images and moving images that make use of a spatial light modulator (SLM) use a bright light that either reflects off or shines through the SLM to project images onto a display screen. These display systems have enabled large high-quality displays that are relatively inexpensive, compact for the display size, and reliable.

One important factor in determining image quality is the display system's bit-depth, defined as a ratio of the display system's brightest white to its darkest black. The greater the bit-depth, the smoother the displayed image appears on the display screen. A display system with a low bit-depth will have visible banding in the images that it displays, especially in portions of the image wherein there are gradual changes in image shading.

One prior art technique that has been used to improve a display system's bit-depth is to physically insert an optical filter, such as a neutral density filter (NDF), into the optical path of the display system. The NDF can reduce the brightness of the light being projected onto the display screen and therefore provide darker blacks. This can result in an increased bit-depth. For SLM display systems that already make use of color filters, the addition of the NDF can be achieved relatively easily and inexpensively.

A second prior art technique that has also been used to improve a display system's bit-depth is to employ a variable aperture that is placed in the optical path of the display system. The aperture can increase or decrease in size and change the amount of light being projected onto the display screen. For example, decreasing the size of the aperture during the display of dark images can increase the darkest of the displayable black and therefore increase the bit-depth of the display system.

One disadvantage of the prior art is that the use of the NDF causes loss of light during the entire time of reduced illumination. The loss of light results in a reduction of overall system brightness.

A second disadvantage of the prior art is that the variable apertures have made use of motors similar to those used in hard disk drives. These motors can be hard to use and may require design expertise not readily available to all display system implementers. This can result in increased display system design and production costs, potentially negating some of the cost benefits of using SLM technology.

### SUMMARY OF THE INVENTION

These and other problems are generally solved or circumvented, and technical advantages are generally achieved, by preferred embodiments of the present invention which provides a system and apparatus for improving image quality in display systems.

In accordance with a preferred embodiment of the present invention, an apparatus is provided. The apparatus includes a planar object with a first side that includes a semi-circular beveled portion (with a tapered cross-section) formed near at least a portion of a perimeter of the planar object and a slot cut along a spine of the semi-circular beveled portion of the planar object and through the planar object. The slot has an inner edge with an inner radius and an outer edge with an outer radius, where at least the inner radius or the outer radius changes with a length of the slot.

In accordance with another preferred embodiment of the present invention, a dynamic aperture is provided. The dynamic aperture includes a planar object that variably passes light that is produced by a light source and a motor coupled to the disc. The planar object includes a semi-circular beveled portion formed on a first side and is formed along at least a portion of a perimeter of the planar object. The motor rotates the disc and changes the amount of light passed by the disc.

In accordance with yet another preferred embodiment of the present invention, a display system for displaying images is provided. The display system includes an array of light modulators that creates images made of pixels by setting each light modulator in the array of light modulators to a state needed to properly display the images, a light source that illuminates the array of light modulators, and a dynamic aperture positioned in an optical path of the display system. The dynamic aperture rotates to variably pass light produced by the light source located on a first side of the dynamic aperture to a second side of the dynamic aperture and includes a planar object with a semi-circular beveled portion formed on the first side of the planar object.

An advantage of a preferred embodiment of the present invention is that standard off-the-shelf motors and feedback systems can be used. This can lead to an easy-to-implement way to increase the display system's bit-depth, potentially improving the image quality of the display system without requiring a significant investment in development time and money. This can further increase a cost advantage of SLM display systems over other display technologies.

A further advantage of a preferred embodiment of the present invention is that the use of standard parts enables practically all display system designers to integrate the present invention into their display systems. Furthermore, the use of time tested parts can reduce design time and costs.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1a and 1b are diagrams of exemplary SLM display systems;

FIG. 2 is a diagram of a detailed view of a dynamic aperture;

FIGS. 3a through 3f are diagrams of front views of dynamic aperture masks and top, cross-sectional views of a display system, according to a preferred embodiment of the present invention;

FIGS. 4a through 4c are diagrams of a top view of a portion of a SLM display system and several exemplary dynamic aperture masks, according to a preferred embodiment of the present invention;

FIGS. 5a through 5c are diagrams of cross-sectional and top views of a dynamic aperture mask, according to a preferred embodiment of the present invention; and

FIGS. 6a through 6c are diagrams of exemplary SLM display systems, according to a preferred embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a SLM display system making use of digital micromirror devices (DMD). The SLM display system may make use of light created from three component (primary) colors, red, green, and blue. The invention may also be applied, however, to other SLM display systems such as those using light modulators with technologies such as liquid crystal, deformable micromirrors, liquid crystal on silicon (LCOS), micro electro-mechanical systems (MEMS), and so forth. Furthermore, the invention has applicability to SLM display systems that makes use of light created from any number of colors, such as four, five, six, and so on.

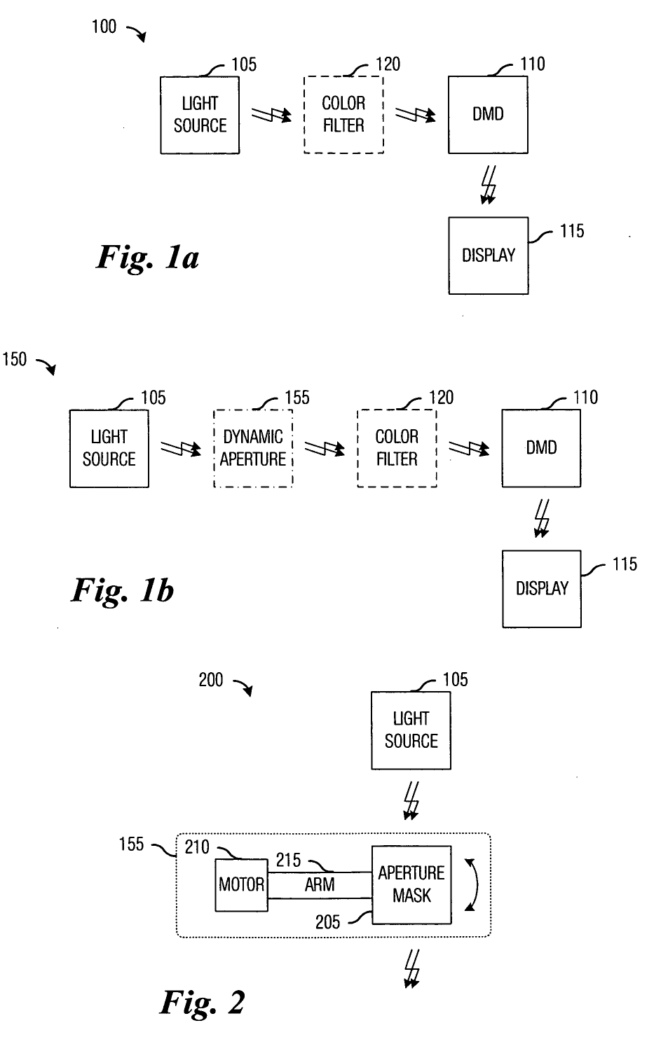

With reference now to FIGS. 1a and 1b, there are shown diagrams illustrating exemplary SLM display systems. The diagram shown in FIG. I a illustrates a SLM display system 100 comprising a light source 105, a DMD 110, and an image plane 115. Light from the light source 105 can reflect off the DMD 110 and onto the image plane 115. With other SLM display technologies, light from the light source 105 may pass through an SLM and onto the image plane 115. Micromirrors on the surface of the DMD 110 can either reflect light towards the image plane 115 or away from the image plane 115. The light modulation by the DMD 110 creates images on the image plane 115.

Depending upon the nature of light produced by the light source 105, a color filter 120 can be placed in an optical path between the light source 105 and the DMD 110 to provide light of desired color. For example, if the light source 105 is a high-intensity arc lamp that produces a wide-spectrum white light, the color filter 120 may be needed to break up the light from the light source 105 into narrow-spectrum light. Typically, wide-spectrum light can be filtered to produce light in red (R), green (G), and blue (B) color components. The color filter 120 may not be necessary if the light source 105 is capable of producing light in the desired color components. Although shown positioned in the optical path between the light source 105 and the DMD 110, it is possible to place the color filter 120 in between the DMD 110 and the image plane 115. While the discussion above covers a three-color display system, the present invention can be applicable to display systems that make use of an arbitrary number of colors and therefore should not be construed as being limiting to the scope or spirit of the present invention.

The diagram shown in FIG. 1b illustrates a SLM display system 150 that is similar to the SLM display system 100 (FIG. 1a) with the exception of a dynamic aperture 155 positioned in the optical path between the light source 105 and the color filter 120 and the DMD 110. If the color filter 120 is not necessary in the SLM display system 150, then it can be removed without affecting the performance of the SLM display system 150. The dynamic aperture 155 can be used to increase the bit-depth of the SLM display system 150 by reducing the amount of light produced by the light source 105 that strikes the DMD 110 and is subsequently displayed on the image plane 115. A reduction in the amount of light displayed on the image plane 115 can yield darker blacks, thereby increasing the ratio of brightest whites to darkest blacks (increasing the contrast of the SLM display system 150).

Although shown positioned in the optical path between the light source 105 and the color filter 120, it is possible to place the dynamic aperture 155 between the color filter 120 and the DMD 110 or between the DMD 110 and the image plane 115. If the color filter 120 is not present in a SLM display system, then the dynamic aperture 155 may be located between the light source 105 and the DMD 110 or between the DMD 110 and the image plane 115.

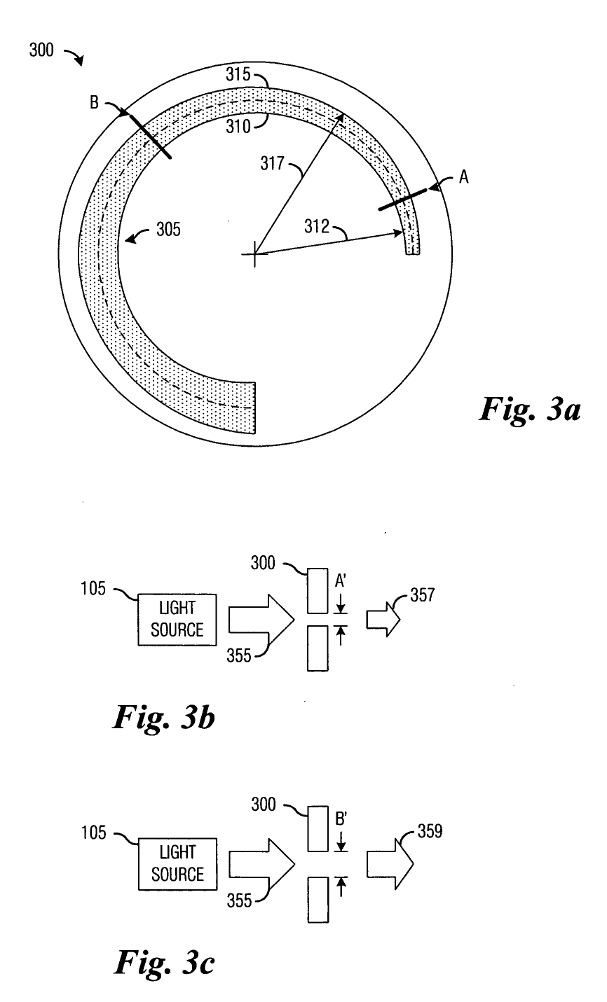

With reference now to FIG. 2, there is shown a diagram illustrating a portion of a SLM display system 200 with a detailed view of a dynamic aperture 155. The diagram shown in FIG. 2 illustrates the SLM display system 200 with the dynamic aperture 155 located in the optical path between the light source 105 and the DMD 110 (not shown in FIG. 2). The dynamic aperture 155 includes an aperture mask 205 that can be moved by a motor 210, with the aperture mask 205 being coupled to the motor 210 by an arm 215. The aperture mask 205 may have a plurality of different sized apertures that can be moved in front of the light source 105 to provide differing amounts of attenuation of light produced by the light source 105. For example, if a small amount of light attenuation is desired, then the aperture mask 205 can be positioned so that a relatively large aperture is placed in front of the light source 105, while if a large amount of light attenuation is desired, then the aperture mask 205 can be positioned so that a relatively small aperture is placed in front of the light source 105.

The diagram shown in FIG. 2 illustrates an embodiment of the dynamic aperture 155 wherein the aperture mask 205 is moved radially by the motor 210. A variant of the dynamic aperture 155 exists where the aperture mask 205 is moved linearly by the motor 210. The precision required to accurately position apertures of desired sizes in front of the light source 105 may mandate a high level of precision in the motor 210. For example, a typical motor may be of a type that is similar to the motors used in computer hard drives. The motors used in computer hard drives are precise and they can be expensive. Furthermore, the use of these motors can require the implementation of specialized feedback control systems. Additionally, the motors can be difficult to design, requiring system designers with prior experience. This level of experience may not be available at every display system manufacturer.

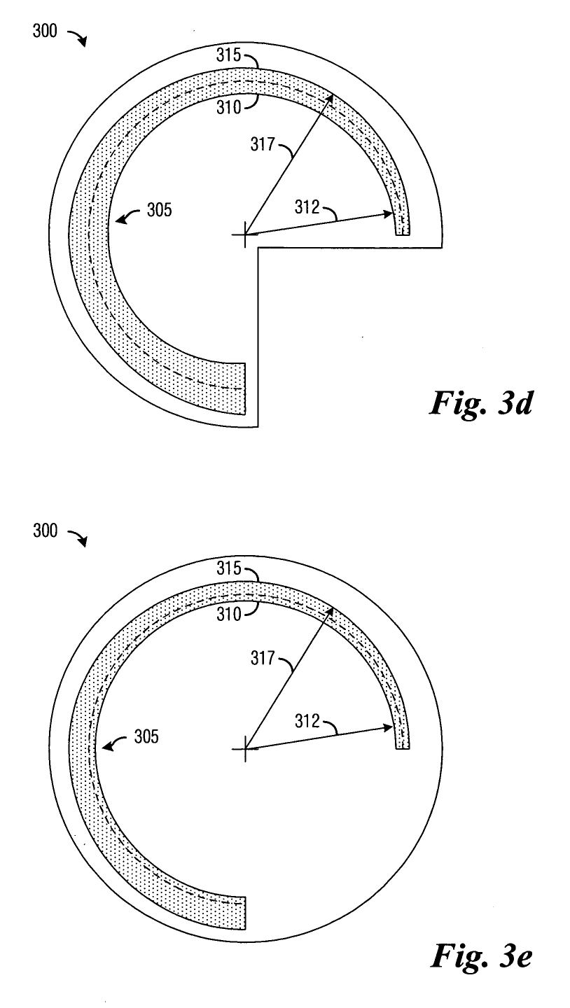

With reference now to FIG. 3a, there is shown a front view of a simplified dynamic aperture mask 300 that can be implemented using standard off-the-shelf motors and without advanced design experience, according to a preferred embodiment of the present invention. The diagram shown in FIG. 3a illustrates a front view of the dynamic aperture mask 300. The dynamic aperture mask 300 can have a disc-like appearance with a slot 305 that is cut through the dynamic aperture mask 300. The dynamic aperture mask 300 can be made from an optically opaque material, such as a metal (for example, aluminum, steel, and so on), a plastic, and so forth, so that it can block the transmission of light from the light source 105. The dynamic aperture mask 300 can be manufactured from a stamping, a casting, a forging, or so on. The slot 305, which is cut completely through the dynamic aperture mask 300, permits light from the light source 105 to shine through the dynamic aperture mask 300, with an attenuation dependent upon a size of the slot 305 in front of the light source 105.

The slot 305 can be formed by cutting two spirals into the dynamic aperture mask 300, wherein at least one spiral has a property that a radius of the spiral changes with rotation. For example, the radius of one of the spirals (or of both spirals) may change linearly with rotation. The two spirals form an inner edge 310 and an outer edge 315 of the slot 305. The inner edge 310 can have a radius 312 while the outer edge 315 can have a radius 317. For the dynamic aperture mask 300 shown in FIG. 3a, both radii change linearly with rotation. As shown in FIG. 3a, the radius 312 decreases linearly and the radius 317 increases linearly as they sweep in a counter-clockwise direction, while the radius 312 increases linearly and the radius 317 decreases linearly as they sweep in a clockwise direction. Both the inner edge 310 and the outer edge 315 should behave in a complementary fashion, i.e., one radius should increase while the other should decrease in order to form a proper slot 305. The width of the slot 305 should change monotonically. Additionally, the inner edge 310 should have a smaller initial value for the radius 312 than that of the radius 317 of the outer edge 315. An Archimedes spiral can be an example of a spiral that has the property of a linearly changing radius with rotation. Although the diagram shown in FIG. 3a illustrates a slot with the inner radius 312 and the outer radius 317 that changes linearly with rotation, the present invention is applicable with radii that exhibit other behavior and therefore should not be construed as limiting either the spirit or the scope of the present invention.

With reference now to FIGS. 3b and 3c, there are shown diagrams illustrating the light attenuation of the dynamic aperture mask 300 at two exemplary points on the slot 305, according to a preferred embodiment of the present invention. The diagram shown in FIG. 3b illustrates a top, cross-sectional view of a portion of the dynamic aperture mask 300 that is immediately in front of the light source 105 (also shown), wherein the dynamic aperture mask 300 is rotated so that the slot 305 at position denoted by point “A” (shown in FIG. 3a) is in front of the light source 105. The light source 105 is capable of producing a specified amount of light, illustrated as a large arrow 355. Since the slot 305 at point “A” is relatively small, only a relatively small amount of light, illustrated as a small arrow 357, passes through the slot 305, with the remainder of the light produced by the light source 105 being blocked by the dynamic aperture mask 300. The diagram shown in FIG. 3c illustrates a side, cross-sectional view of the dynamic aperture mask 300 that also includes the light source 105, wherein the dynamic aperture mask 300 is rotated so that the slot 305 at position denoted by point “B” (shown in FIG. 3a) is in front of the light source 105. The size of the slot 305, B′, at point “B” is significantly larger than the size of the slot 305, A′, at point “A.” Therefore, the amount of light that passes through the slot 305, shown as large arrow 359, is greater than the small arrow 357 of FIG. 3b.

Hence, to attenuate a large amount of light, the dynamic aperture mask 300 can be rotated so that the size of the slot 305 that is in front of the light source 105 is small, while to attenuate a small amount of light, the dynamic aperture mask 300 can be rotated so that the size of the slot 305 that is in front of the light source 105 is large.

The size of the slot 305 (both in terms of the width of the slot 305 and the length of the slot 305) formed into the dynamic aperture mask 300 can be dependent upon a number of factors, such as a range of light attenuation desired, the granularity of the light attenuation desired, a size of the light source, the amount of heat produced by the light source 105 that must be dissipated, the required transition time for changing light attenuation, and so forth. For example, if a high degree of granularity of the light attenuation is desired, then the slot 305 will likely need to be long with gradually changing radii, while if a short transition time for changing light attenuation is desired, then the slot 305 will likely need to be short with rapidly changing radii.

With reference now to FIGS. 3d through 3f, diagrams illustrate other exemplary dynamic aperture masks 300, according to a preferred embodiment of the present invention. A diagram shown in FIG. 3d illustrates a dynamic aperture mask 300 that is not a complete disc. Rather, the dynamic aperture mask 300 has as much material as necessary to form the slot 305. For example, if a slot 305 spanned only 90 degrees of rotation, then a dynamic aperture mask 300 for such a slot would have the appearance of a quarter-circle. An advantage of such an embodiment can be that the overall mass of the dynamic aperture mask 300 can be reduced, therefore, it can be possible to more rapidly put the dynamic aperture mask 300 into motion as well as stop a moving dynamic aperture mask 300. This may enable the use of a smaller and less powerful motor to move the dynamic aperture mask 300.

A diagram shown in FIG. 3e illustrates a dynamic aperture mask 300 wherein one radius of the slot 305 remains constant. As shown in FIG. 3e, the inner radius 312 of the slot remains constant while the outer radius 315 changes with rotation. With the inner radius 312 remaining constant, the inner edge 310 does not change with rotation.

A diagram shown in FIG. 3f illustrates a dynamic aperture mask 300 wherein the dynamic aperture mask 300 does not feature a slot. Instead, an outer edge 355 of the dynamic aperture mask 300 can be used to attenuate the light from the light source 105. The outer edge 355 (as described by a radius 357) of the dynamic aperture mask 300 can vary with rotation in a manner similar to the inner edge 310 of the slot 305, for example. To attenuate a large amount of light, the dynamic aperture mask 300 can be rotated so that a portion of the dynamic aperture mask 300 with a large radius 357 is in front of the light source 105 (for example, point C), while to attenuate a small amount of light, the dynamic aperture mask 300 can be rotated so that a portion of the dynamic aperture mask 300 with a small radius 357 is in front of the light source 105 (for example, point D). A shaded area 359 illustrates portions of the dynamic aperture mask 300 cut to create an edge that varies with rotation.

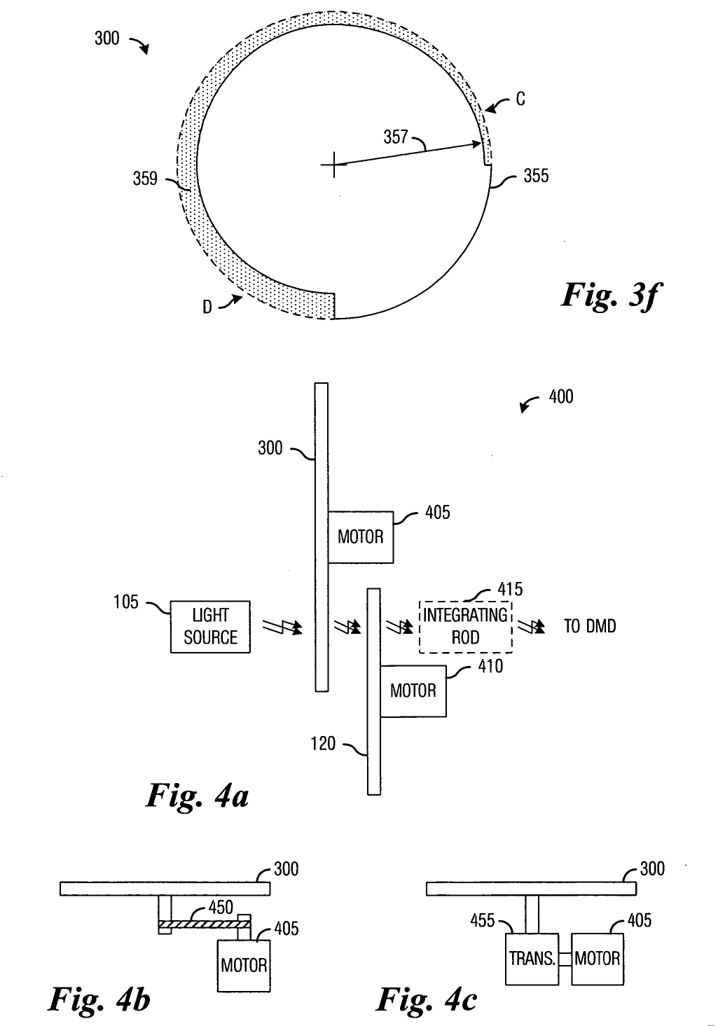

With reference now to FIG. 4a, there is shown a diagram illustrating a top view of a portion of an exemplary SLM display system 400, wherein the dynamic aperture mask 300 is positioned in an optical path of the exemplary 400 between the light source 105 and a DMD, according to a preferred embodiment of the present invention. The dynamic aperture mask 300 is shown in FIG. 4a as being positioned between the light source 105 and the color filter 120, however, it is possible to position the dynamic aperture mask 300 in other positions within the optical path, such as between the color filter 120 and the DMD 110 (not shown) as well as in other positions in the optical path as discussed previously.

The dynamic aperture mask 300, which, according to a preferred embodiment of the present invention, must be rotated radially in order to variably attenuate the amount of light produced by the light source 105 that actually reaches the DMD 110, can be attached to a motor 405. The motor 405 may be a standard off-the-shelf direct current (DC) brushless motor. DC brushless motors are inexpensive, perform well, and there are many design engineers that have had experience with designing systems with DC brushless motors. Therefore, the use of the motor 405 to rotate the dynamic aperture mask 300 can be readily implemented with little design and development time and without the need for system designers with specialized experience. Additionally, the DC brushless motors can make use of readily available feedback sensors and feedback control systems. This can further simplify the design of the SLM display system 400. Alternatively, limited angle torque (LAT) motors can be used as the motor 405. LAT motors are also inexpensive and provide good performance and can further simplify control circuitry design.

A second motor 410 can also be used to control the color filter 120, which preferably is a multi-segmented color disc. The second motor 410 may be of a similar design to the motor 405. Although the second motor 410 may be similar to the motor 405, the second motor 410 may even be simpler in design since the second motor 410 is only required to rotate the color filter 120 at a specified angular velocity without additional performance requirements such as the ability to start, stop, reverse direction, and so forth. An integrating rod 415 can be used to correct non-uniform light produced by the light source 105 and provide a light that is more uniform. The presence of the integrating rod 415 may be optional and can be dependent upon the nature of the light being produced by the light source 105.

Depending upon a desired amount of attenuation of the light produced by the light source 105, the dynamic aperture mask 300 can be rotated so that a portion of the slot 305 (not shown) is directly in front of the light source 105. Referring back to FIG. 3a, the motor 405 can rotate the dynamic aperture mask 300 either in a clockwise direction or a counter-clockwise direction. A feedback control signal line (not shown) can provide control information to a controller (also not shown) to indicate if the dynamic aperture mask 300 is in the desired position. For example, an optical sensor can detect the amount of light from the light source 105 that is striking the DMD 110. If control information from the optical sensor indicates that the amount of light is too large, then the motor 405 can rotate the dynamic aperture mask 300 to further reduce the size of the slot 305. Alternatively, the dynamic aperture mask 300 may have some sensors embedded along its perimeter that can be used to determine the size of the slot 305 in front of the light source 105, for example, by detectors that are capable of determining the position of the dynamic aperture mask 300 by detecting the sensors passing by.

The diagram shown in FIG. 4a illustrates an embodiment of the present invention wherein the dynamic aperture mask 300 is directly driven by the motor 405, i.e., a shaft (not shown) of the motor 405 is coupled to the dynamic aperture mask 300 and rotations of the shaft directly translate into rotations of the dynamic aperture mask 300. However, there are other preferred embodiments for driving the dynamic aperture mask 300 with the motor 405. The diagrams shown in FIGS. 4b and 4c illustrate two exemplary ways to drive the dynamic aperture mask 300 with the motor 405, according to a preferred embodiment of the present invention. As shown in FIG. 4b, rather than being directly driven by a shaft from the motor 405, the dynamic aperture mask 300 may be driven by a belt 450 (or a chain, a band, a toothed loop, or so forth) that is coupled to a shaft from the motor 405 and a shaft from the dynamic aperture mask 300. As shown in FIG. 4c, a transmission 455 can be used to couple the motor 405 to the dynamic aperture mask 300. The use of the transmission 455 can provide a measure of mechanical gain that can help more rapidly move the dynamic aperture mask 300 into a desired position or provide more accurate positioning of the dynamic aperture mask 300, for example.

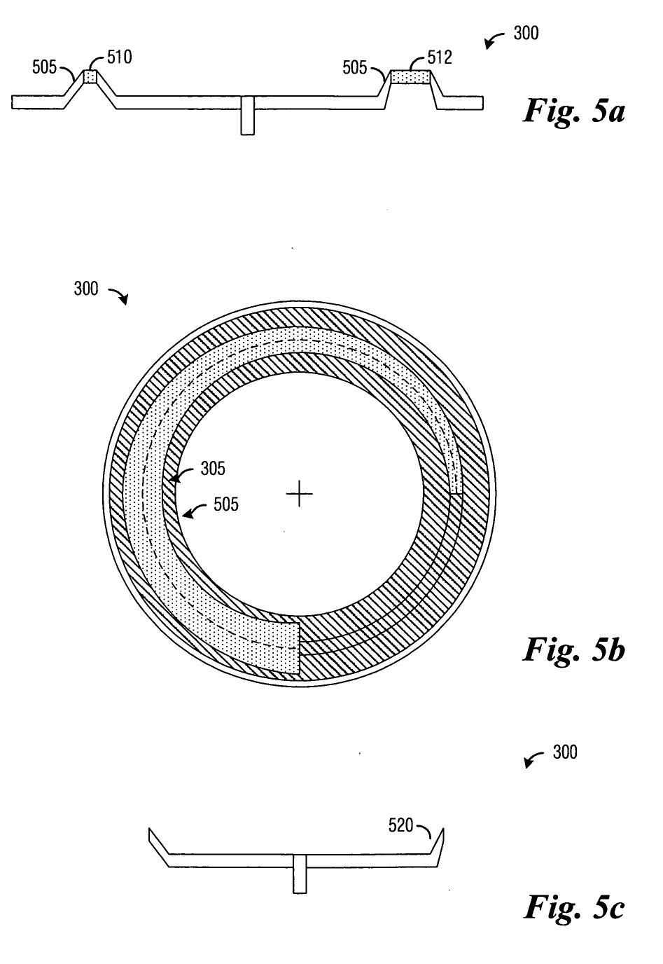

With reference now to FIGS. 5a through 5c, there are shown diagrams illustrating a detailed view of cross-sectional views and a top view of a dynamic aperture mask 300, according to a preferred embodiment of the present invention. The diagram shown in FIG. 5a illustrates a detailed cross-sectional view of the dynamic aperture mask 300. The cross-sectional view of the dynamic aperture mask 300 shows that the dynamic aperture mask 300 features an exemplary beveled (or raised) portion 505 within which the slot 305 is cut. The slot 305 is cut along a spine of the beveled portion 505, with the surface of the beveled portion 505 falling away from the inner edge and the outer edge of the slot 305. Although shown as featuring sharp edges and angles, the beveled portion 505 can be created in such a manner as to have rounded edges and gentle angles. For example, the dynamic aperture mask 300 shown in FIG. 5a can be formed from a stamped metal disc.

The diagram shown in FIG. 5a illustrates a narrow portion 510 of the slot 305 cut through the beveled portion 505 and a wide portion 512 of the slot 305 cut through the beveled portion 505. The diagram shown in FIG. 5a illustrates a beveled portion 505 with a width that varies with a width of the slot 305 being cut through it (for example, the width of the beveled portion 505 is smaller with the narrow portion 510 than the width of the beveled portion 505 with the wide portion 512). A view of a top side of the dynamic aperture mask 300 (FIG. 5b) would show that the beveled portion 505 encompasses the slot 305. The beveled portion 505 may encircle the entire dynamic aperture mask 300, as shown in FIG. 5b, or if the slot 305 does not encircle the dynamic aperture mask 300, the beveled portion 505 may also not encircle the dynamic aperture mask 300.

Since the light source 105 can produce a significant amount of heat as well as light, the beveled portion 505 can be used to help deflect some of the light that is not passing through the slot 305 to reduce the amount of heat build-up in the dynamic aperture mask 300. Furthermore, the beveled portion 505 can also help to reduce the amount of light (and heat) that is reflected off the surface of the dynamic aperture mask 300 back to the light source 105. Since the surface of the beveled portion 505 is not orthogonal to the light source 105, the light reflecting off the dynamic aperture mask 300 will likely not reflect back to the light source 105. If too much light (and heat) is reflected back to the light source 105, the light source 105 may overheat and potentially become damaged. Additionally, the surface of the dynamic aperture mask 300 should be coated with a reflective material so that the dynamic aperture mask 300 will not absorb too much of the heat generated by the light source 105.

The diagram shown in FIG. 5c illustrates a cross-sectional view of a dynamic aperture mask 300, wherein the outer edge the dynamic aperture mask 300 is used to attenuate the light produced by the light source 105, such as shown in FIG. 3f. In a situation, a beveled portion may still be used to help prevent light from reflecting directly back to the light source 105 and overheating the light source 105. Rather than having bevels on both sides of the slot (as shown in FIG. 5b), a bevel 520 can be formed along the edge of the dynamic aperture mask 300.

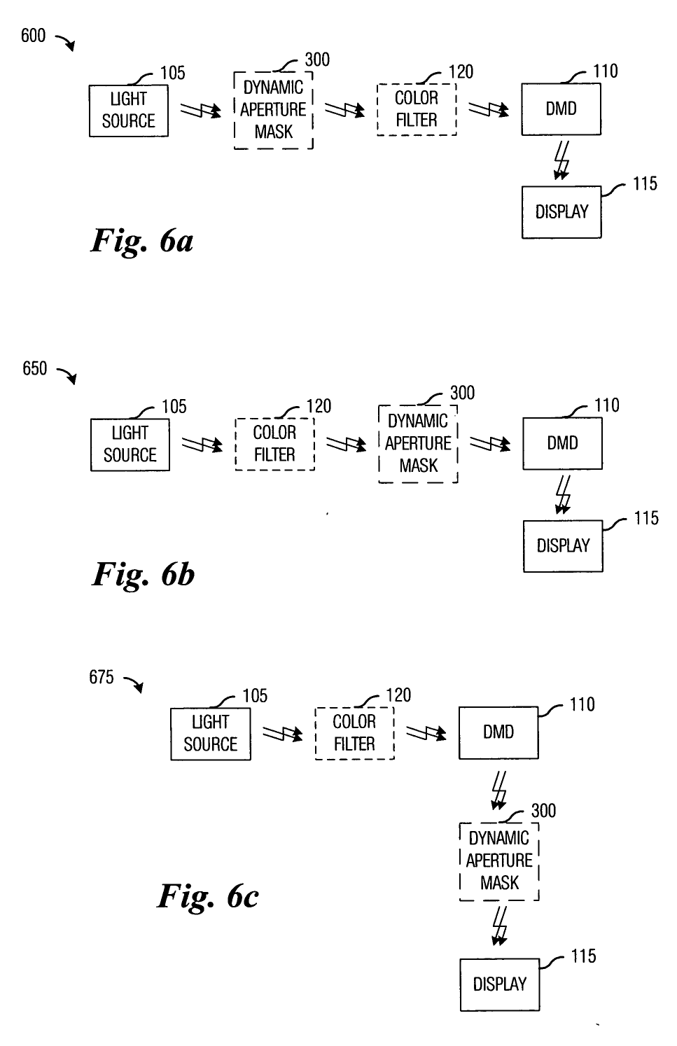

With reference now to FIGS. 6a through 6c, there shown diagrams illustrating exemplary SLM display systems, according to a preferred embodiment of the present invention. The diagrams shown in FIGS. 6a through 6c illustrate SLM display systems with different locations for the dynamic aperture mask 300. The diagram shown in FIG. 6a illustrates a SLM display system 600 with the dynamic aperture mask 300 located in the optical path between the light source 105 and the color filter 120. The diagram shown in FIG. 6b illustrates a SLM display system 650 with the dynamic aperture mask 300 located in the optical path between the color filter 120 and the DMD 110. The diagram shown in FIG. 6c illustrates a SLM display system 675 with the dynamic aperture mask 300 located in the optical path between the DMD 110 and the image plane 115. The diagram shown in FIG. 6c may be illustrative of what is commonly referred to as a “rear-projection display system.” To make use of the dynamic aperture mask 300 in a rear-projection display system, it may be necessary to change the surface of the dynamic aperture mask 300 from a reflective surface to a dark absorptive surface.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An apparatus comprising:
a planar object having a first side with a semi-circular beveled portion formed near at least a portion of a perimeter of the planar object, the semi-circular beveled portion having a tapered cross-section; and
a slot cut along a spine of the semi-circular beveled portion of the planar object and through the planar object, the slot having an inner edge with an inner radius and an outer edge with an outer radius, wherein at least the inner radius or the outer radius changes with a length of the slot.

2. The apparatus of claim 1, wherein a surface of the tapered cross-section of the semi-circular beveled section along the inner edge recedes from the inner edge and a surface of the tapered cross-section of the semi-circular beveled section along the outer edge of the slot recedes from the outer edge.

3. The apparatus of claim 1, wherein arcs formed by the inner edge of the slot and the outer edge of the slot are Archimedes arcs.

4. The apparatus of the claim 3, wherein a width of the slot changes monotonically along the length of the slot.

5. The apparatus of the claim 3, wherein the radius of the inner edge and the radius of the outer edge of the slot change in a complementary fashion along the length of the slot.

6. The apparatus of claim 1, wherein the disc is made from a metallic material.

7. The apparatus of claim 1, wherein the first side of the disc is coated with a reflective material.

8. A dynamic aperture comprising:
a planar object configured to variably pass light produced by a light source located on a first side of the side of the planar object to a second side of the planar object, wherein the planar object comprises a semi-circular beveled portion formed on a first side of the planar object, the semi-circular beveled portion formed along at least a portion of a perimeter of the planar object; and
a motor coupled to the planar object, the motor configured to rotate the planar object and change the amount of light passed by the planar object.

9. The dynamic aperture of claim 8, wherein the semi-circular beveled portion has a tapered cross-section, and wherein planar object comprises a slot cut along a spine of the semi-circular beveled portion of the planar object and through the planar object, the slot having an inner edge with an inner radius and an outer edge with an outer radius, wherein at least the inner radius or the outer radius changes along with a length of the slot.

10. The dynamic aperture of claim 9, wherein the inner edge of the slot and the outer edge of the slot are Archimedes spirals.

11. The dynamic aperture of claim 8, wherein the planar object is coupled to the motor via a drive shaft.

12. The dynamic aperture of claim 8, wherein the planar object further comprises a drive shaft located at a center of the disc, and wherein a belt couples the drive shaft to the motor.

13. The dynamic aperture of claim 8, wherein a transmission couples the planar object to the motor.

14. The dynamic aperture of claim 8, wherein the motor is a DC brushless motor.

15. The dynamic aperture of claim 8, wherein the motor is a limited angular torque motor.

16. The dynamic aperture of claim 8, wherein the semi-circular beveled portion is formed on a perimeter of the dynamic aperture, and wherein a radius describing the perimeter of the dynamic aperture varies with a length of the semi-circular beveled portion.

17. A display system for displaying images, the display system comprising:
an array of light modulators configured to create images comprised of pixels by setting each light modulator in the array of light modulators into a state needed to properly display the images;
a light source to illuminate the array of light modulators, wherein a light from the light source reflecting off the array of light modulators forms the images on an image plane; and
a dynamic aperture positioned in an optical path of the display system, wherein the dynamic aperture rotates to variably pass light produced by the light source located on a first side of the dynamic aperture to a second side of the dynamic aperture, the dynamic aperture configured to attenuate the light produced by the light source, the dynamic aperture comprising a planar object with a semi-circular beveled portion formed on the first side of the planar object.

18. The display system of claim 17, wherein the semi-circular beveled portion has a tapered cross-section, and wherein planar object comprises a slot cut along a spine of the semi-circular beveled portion of the planar object and through the planar object, the slot having an inner edge with an inner radius and an outer edge with an outer radius, wherein at least the inner radius or the outer radius changes along with a length of the slot.

19. The display system of claim 17, wherein the dynamic aperture is positioned between the light source and the array of light modulators.

20. The display system of claim 17, wherein the array of light modulators is an array of spatial light modulators.

21. The display system of claim 20, wherein the array of light modulators is a digital micromirror device.
